(19) United States
(12) Patent Application Publication
(10) Pub. No.: US 2013/0151978 A1
(43) Pub. Date: Jun. 13, 2013

(54) METHOD AND SYSTEM FOR CREATING SMART CONTENTS BASED ON CONTENTS OF USERS

(71) Applicant: Electronics and Telecommunications Research Institute, Daejeon (KR)

(72) Inventor: Sang Hyun JOO, Daejeon (KR)

(73) Assignee: Electronics and Telecommunications Research Institute, Daejeon (KR)

(21) Appl. No.: 13/684,082

(22) Filed: Nov. 21, 2012

(30) Foreign Application Priority Data
Nov. 23, 2011 (KR) 10-2011-0122919

(51) Int. Cl. G06F 3/0481

(52) U.S. Cl. CPC G06F 3/04817
USPC 715/738; 715/846

(57) ABSTRACT

Provided is a method of managing content using a visual expression, the method including: determining a visual icon that represents each of contents registered by users, based on the respective contents; quantizing each of a plurality of visual icons to map each of the plurality of visual icons with at least one level among a plurality of predetermined quantization levels; generating a content unit corresponding to each of the plurality of visual icons based on the mapping result; and creating smart content that is a visual expression as abstract information corresponding to a combination of the contents, based on a combination of content units.

### CROSS-REFERENCE TO RELATED APPLICATION

This application claims the priority benefit of Korean Patent Application No. 10-2011-0122919, filed on Nov. 23, 2011, in the Korean Intellectual Property Office, the disclosure of which is incorporated herein by reference.

### BACKGROUND

1. Field of the Invention

Embodiments of the following description relate to technology of creating smart content using a visual expression that represents contents of users.

2. Description of the Related Art

Various types of contents registered by a plurality of users are present in an online communication network. For example, in a social network service, each of the users may freely register the user's opinion on a corresponding issue.

As one example, with respect to a predetermined product, for example, a notebook and a smart phone, each of the global users may upload the user's opinion to a website such as a bulletin board, twitter, or facebook using the user's mother language.

Accordingly, opinions of users may be present on a social network without being arranged and thus, it may be difficult to grasp what the opinions of the users actually relate to. Users who are not familiar with a corresponding language may not readily understand opinions of other users.

As another example, with respect to a predetermined social issue, each of the users may express an opinion in various ways such as consent, dissent, and the like. However, when opinions of the users are not well organized, it may be difficult to grasp what general opinions of the users are.

### SUMMARY

According to an aspect of the present invention, there is provided a method of managing content using a visual expression, the method including: determining a visual icon that represents each of contents registered by users, based on the respective contents; quantizing each of a plurality of visual icons to map each of the plurality of visual icons with at least one level among a plurality of predetermined quantization levels; generating a content unit corresponding to each of the plurality of visual icons based on the mapping result; and creating smart content that is a visual expression as abstract information corresponding to a combination of the contents, based on a combination of content units.

The quantizing may include quantizing each of the plurality of visual icons by further referring to a sentiment index or an emotional index that is predetermined with respect to community of the users.

The creating may include visually combining the content units and selecting the combination result as the smart content.

The creating may include searching for a new content unit based on information that is commonly included in the quantization results of the plurality of visual icons, and selecting the new content unit as the smart content.

The creating may include searching for a new content unit based on all of or a portion of information that is included in the quantization results of the plurality of visual icons, and selecting the new content unit as the smart content.

The content management method may further include receiving, from a social network service (SNS) server, the contents that are registered by the users.

The smart may include a video or an image.

The content management method may further include updating the smart content in response to a new content being provided.

The content management method may further include playing the created smart content.

According to another aspect of the present invention, there is provided a system for managing content using a visual expression, the system including: a receiver to receive, from an SNS server, contents that are registered by users; a visual icon determining unit to determine a visual icon that represents each of the contents based on the respective contents; a quantization unit to quantize each of a plurality of visual icons to map each of the plurality of visual icons with at least one level among a plurality of predetermined quantization levels; a content unit generator to generate a content unit corresponding to each of the plurality of visual icons based on the mapping result; and a smart content creator to create smart content that is a visual expression as abstract information corresponding to a combination of the contents, based on a combination of content units.

The smart content creator may create the smart content corresponding to the combination of contents by further referring to smart content created in another social community.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram to describe a concept of a visual icon, a content unit, and smart content according to an embodiment of the present invention;

FIG. 2 is a diagram illustrating a system according to an embodiment of the present invention;

FIG. 3 is a diagram illustrating an example of employing a system according to an embodiment of the present invention;

FIGS. 4 through 6 are views illustrating examples of creating smart content by the system of FIG. 2 according to an embodiment of the present invention;

FIG. 7 is a block diagram illustrating a configuration of a system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

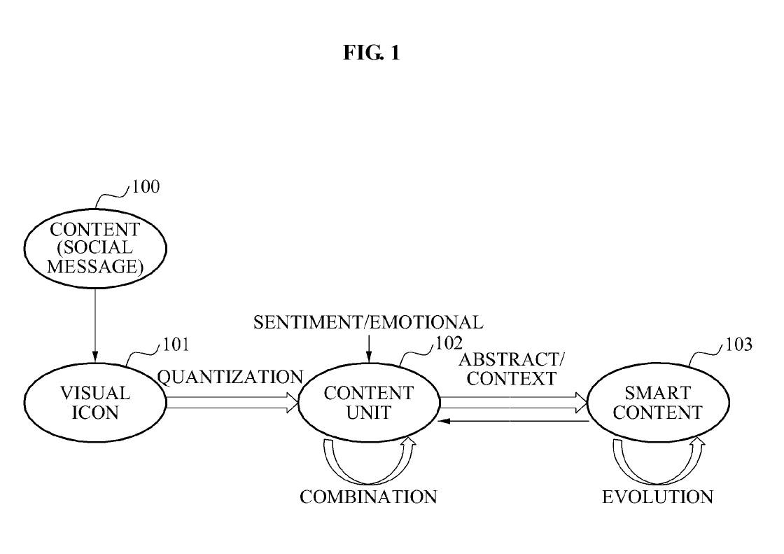

FIG. 1 is a diagram to describe a concept of a visual icon 101, a content unit 102, and smart content 103 according to an embodiment of the present invention.

Referring to FIG. 1, each of users may register a social message as content 100 in a social network service such as twitter, facebook, and the like. The content 100 may be provided using various formats, such as a text, an image, a moving picture, a flash, and the like, for example.

Each of the users may register a social message using a predetermined language. According to an embodiment of the present invention, the social message may be expressed as the visual icon 101. A user may also select the visual icon 101 together with the social message.

A system according to an embodiment of the present invention may include a database to perform word quantization of contents that are registered by users. For example, by performing word quantization of and analyzing the content 100, the content 100 may be matched with “happy” in English, “le Bonheur” in French, “Gluck” in German, and “felicità” in Italian. In this case, the visual icon 101 corresponding to the content 100 may be determined to be “ [symbol] ”.

The above visual icon 101 may be configured based on a video image, a three-dimensional (3D) object image, an animation image, and a character image, and may also be mapped in advance with a word or a group of words.

When the contents 100 are registered by the users, the corresponding visual icon 101 may be selected by each of the users, or the visual icon 101 corresponding to each of the contents 100 may be automatically created.

When the visual icons 101 are determined, the content unit 102 may be generated by quantizing each of the visual icons 101. As one example, a human's feeling about “like” and “dislike” may be quantized to ten levels, and each visual icon 101 may be mapped to a single quantization level. Each of the quantization levels may have a single content unit 102. As another example, a human's feeling about “tasty” and “untasty” may be quantized to five quantization levels. Each of the visual icons 101 corresponding to the content 100 may be mapped to one of the five quantization levels and thereby be converted to the content unit 102.

When generating the content unit 102, a sentiment index or an emotion index of a social community in which the content 100 is registered may be calculated based on a feature and a history of the social community and the like. The content unit 102 may be generated by further referring to the calculated sentiment index and emotional index.

For example, when the number of young users is relatively large among users who have joined the social community, a quantization level indicating a characteristic of youths such as “dynamic”, “creative”, and the like may be considered to be further important.

When the content unit 102 corresponding to the content 100 is generated through the aforementioned process, a plurality of content units 102 may be combined with each other based on a predetermined rule. The rule may be predefined. For example, a logical combination, a physical combination, a chemical combination, and the like may be present.

For example, when one content unit indicates a red circle and another content unit indicates a black triangle, a combination of two content units may be expressed using at least one of the logical combination, the physical combination, and the chemical combination.

The result of combination may be referred to as the smart content 103. The smart content 103 may be utilized as abstract information of the contents 100. For example, when one content relates to “good” about a predetermined issue and another content relates to “bad” about the predetermined issue, a first content unit indicating “good” may be expressed as “blue sky” and a second content unit indicating “bad” may be expressed as “sky covered with dark clouds”. As the combination of the first content unit and the second content unit, the smart content 103 may be expressed as “sky slightly covered with clouds”.

Also, the smart content 103 may be self-evolved through combination with the content unit 102 of the content 100 newly added. For example, when a third content unit indicating “sky covered with dark clouds” is further generated, the system may generate new smart content expressing “sky further covered with clouds” than “sky slightly covered with clouds” by combining the existing smart content with the third content unit.

When the smart content 103 is a moving picture, the smart content 103 may be played on a user interface. In this case, information associated with generation and play of the smart content 103 may be referred to as a context. A user may call and play the desired smart content 103 based on context and abstract information.

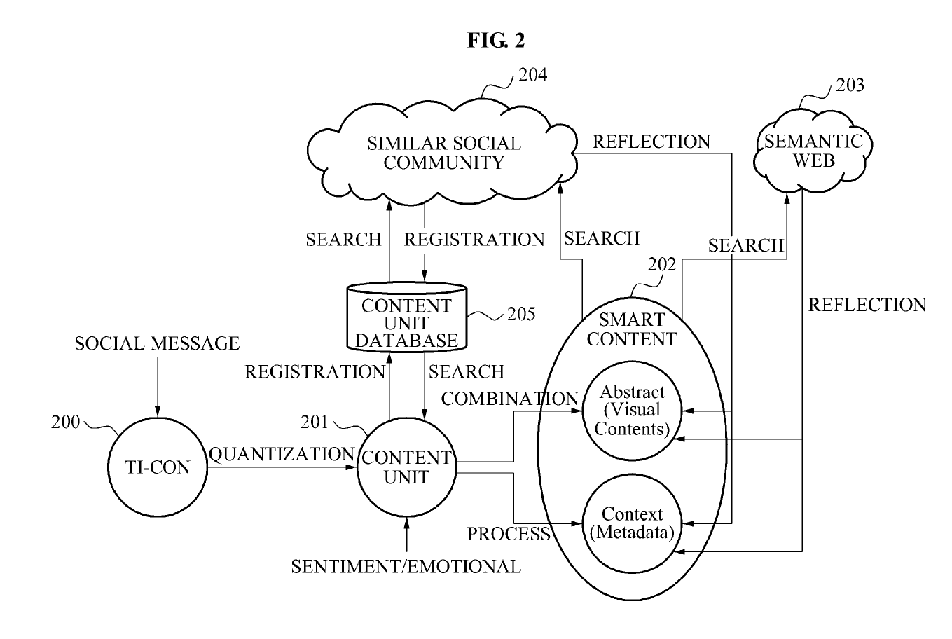

FIG. 2 is a diagram illustrating a system according to an embodiment of the present invention.

Referring to FIG. 2, according to an embodiment of the present invention, a visual icon capable of being referred to as a “ti-con” 200 may be generated from a social message. As described above, the visual icon may be input by users, or may be automatically generated in the system.

The system of the present invention may generate a content unit 201 corresponding to each of contents by quantizing visual icons. According to an embodiment of the present invention, the content unit 201 corresponding to each of the contents may be generated by searching a content unit database 205. When the appropriate content unit 201 is absent in the content unit database 205, the content unit database 205 may be updated by a similar social community 204.

Also, when all the content units 201 are generated, smart content 202 may be created by combining the content units 201 based on a predetermined rule. The smart content 202 may be visual content.

The smart content 202 may indicate abstract information, and may be instructed using corresponding context, for example, metadata. Also, the smart content 202 may interact with an Internet network such as a semantic web 203. For example, users may search for the smart content 202 using the semantic web 203.

Also, the smart content 202 may receive a different social message from the semantic web 203 or the similar social community 204. That is, when the different social message is provided from the semantic web 203 or the similar social community 204, a visual icon corresponding to the social message different from a previous social message may be generated. When the generated visual icon is quantized, a different content unit corresponding to the quantized visual icon may be generated. The smart content 202 may be continuously updated by reflecting the generated different content unit.

Also, the similar social community 204 may provide suitable content units to the content unit database 205. The present invention may be performed in a single social community and may also interact with another social community or semantic web. Through the above interaction, the present invention enables the smart content to be continuously self-evolved.

The present invention may be operated by a plurality of social communities. The plurality of social communities may be physically or conceptually distinguished from each other, and may have upper and lower concepts.

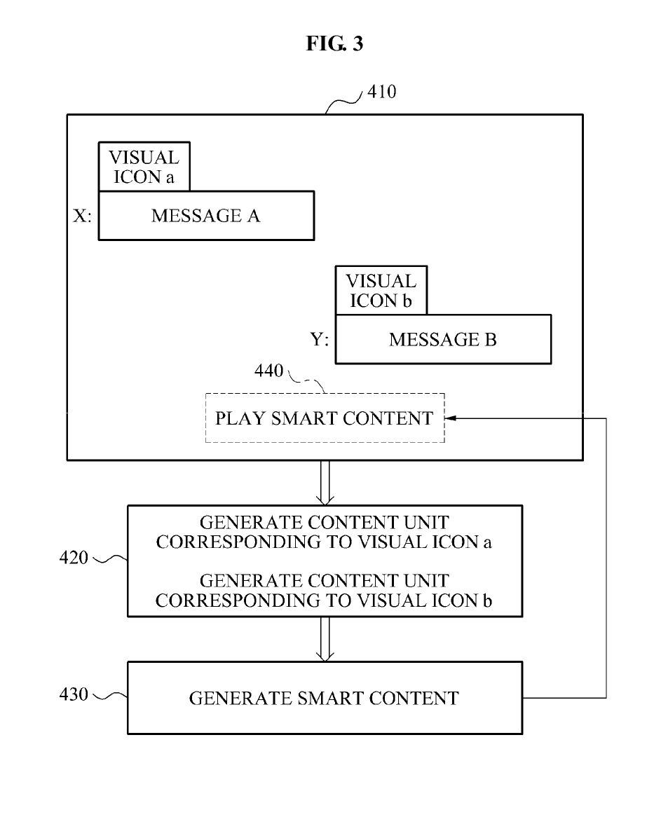

FIG. 3 is a diagram illustrating an example of employing a system according to an embodiment of the present invention.

Referring to FIG. 3, it is assumed that a user X has generated a message A using an instant messaging service and a user Y has generated a message B using the instant messaging service.

As shown in an instant message window 410, it is assumed that the message A registered by the user X corresponds to a visual icon a and the message B registered by the user Y corresponds to a visual icon b.

In operation 420, a content unit corresponding to the visual icon a and a content unit corresponding to the visual icon b may be generated. That is, the content units may be generated, respectively, by mapping each of the visual icon a and the visual icon b to one of predetermined quantization levels.

In operation 430, one smart content may be created by combining two content units based on a predetermined rule. The created smart content may be expressed or played on the instant message window 410. Accordingly, two users may verify abstract information of contents from single smart content in operation 440.

For example, when one user is for a predetermined social issue and another user is against the predetermined social issue, smart content may be expressed in a form of a triangle. In this instance, when still another user updates another content, the smart content may be updated again.

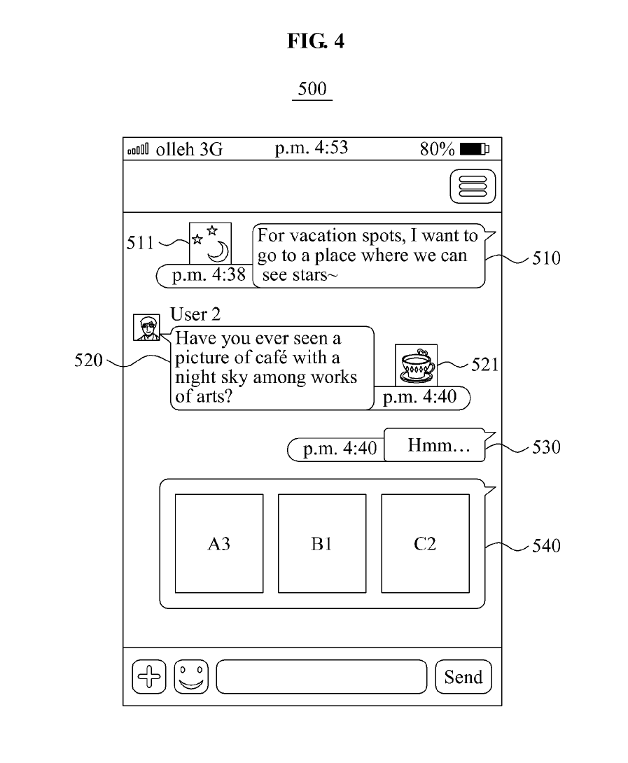

FIGS. 4 through 6 are views illustrating examples of creating smart content by the system of FIG. 2 according to an embodiment of the present invention.

Referring to FIG. 4, a user may utilize an instant messaging service. The system may collect, as a social message, a user message occurring in the instant messaging service. For example, the system may collect, as social messages on a screen 500, messages, for example, a first message 510, a second message 520, and a third message 530.

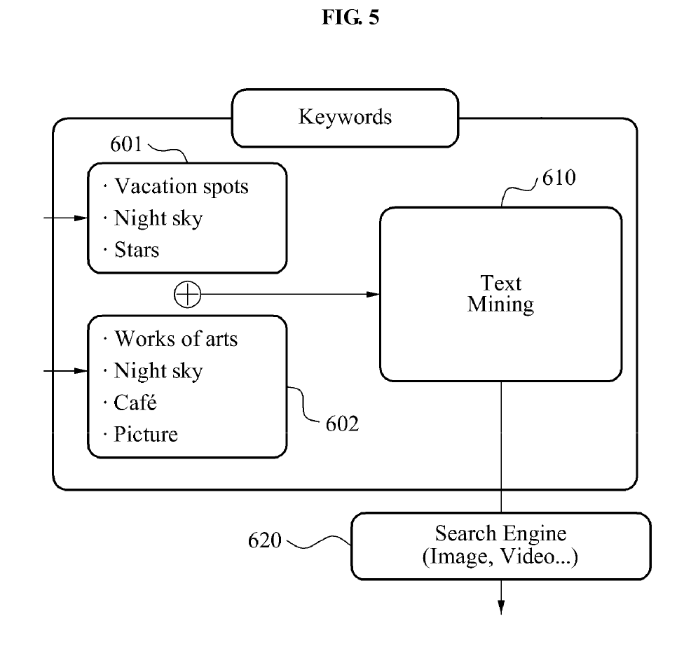

The system may recognize each of the collected social messages as independent content. The system may generate a visual icon corresponding to each of contents. In FIG. 5, a visual icon 511 corresponds to the first message 510 and a visual icon 521 corresponds to the second message 520.

The system may quantize each of the visual icons 511 and 521, and may map quantization levels to the visual icons 511 and 521, respectively, based on the quantization result. For example, a quantization result of the visual icon 511 may include a keyword 601 of FIG. 5 and a quantization result of the visual icon 521 may include keywords 602 of FIG. 5.

The system may generate content units corresponding to the visual icons 511 and 521, respectively, based on the mapping results. For example, the system may search for a content unit database based on the quantization results of the visual icons 511 and 521, and may select a content unit associated with each of the visual icons 511 and 521.

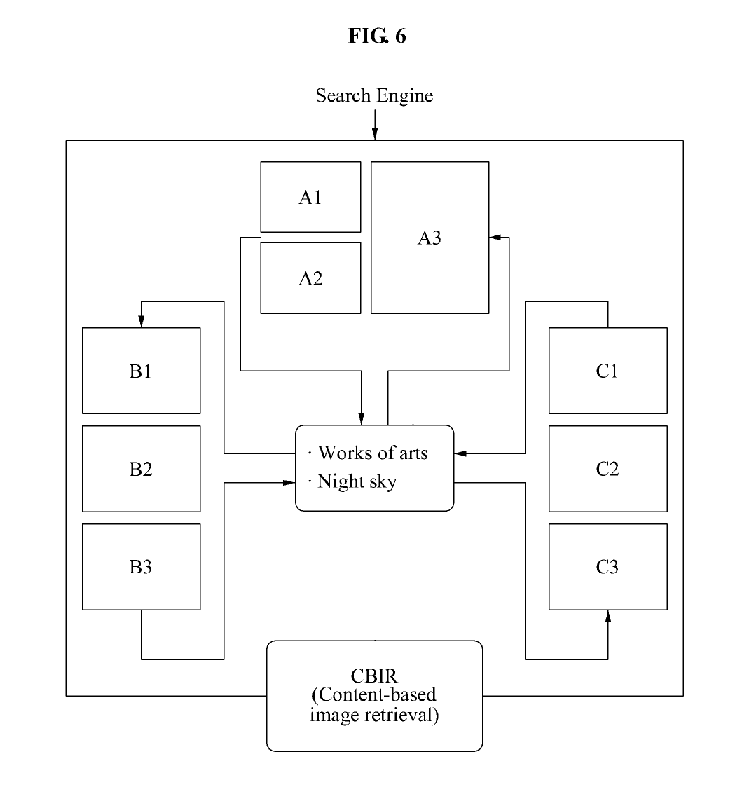

According to an embodiment, the system may utilize the quantization result of a keyword scheme as shown in FIG. 6. The system may search for content units based on the keyword 601 associated with the visual icon 511 and the keyword 602 associated with the visual icon 521. The system may search for a single smart content unit by performing data-mining, for example, text mining 610 of the keyword 601 and the keyword 602. The above search may be performed by a search engine 620.

As shown in FIG. 6, according to an embodiment, the search engine 620 may search the content unit database for at least one content unit, for example, content units A1, A2, and A3 associated with the keyword 601 and at least one content unit, for example, content units B1, B2, and B3 associated with the keyword 602. Here, when a plurality of content units is retrieved with respect to a single keyword, the system may determine that one of the retrieved content units corresponds to the keyword based on a propensity of a user. For example, with respect to the keyword 601, the system may select the content unit A3 from among the content units A1, A2, and A3 by further referring to a propensity of a user, for example, a sentiment index and an emotional index. With respect to the keyword 602, the system may select the content unit B1 from among the content units B1, B2, and B3 by further referring to the propensity of the user, for example, the sentiment index and the emotional index.

The system may create single smart content by combining the content units A3 and B1 of the keywords 601 and 602. The smart content may show a visual expression to indicate abstract information corresponding to the combination of contents. For the above operation, according to an embodiment, the system may visually combine the content units A3 and B1, and may create the combination result as the smart content.

According to another embodiment, the system may search for new content unit to express the combination of the keywords 601 and 602 by referring again to the keywords 601 and 602, and may select the retrieved content unit as smart content. For the above operation, the system may search the content unit database based on description that is commonly included in the keywords 601 and 602. The system may also search the content unit database based on all of or a portion, for example, “works of arts” and “night sky”, of descriptions that are included in the keywords 601 and 602.

When the smart content is selected or created, the system may transfer the smart content to the instant messaging service. A box 540 of FIG. 4 shows the content unit A3 that is generated by the first message 510, the content unit B1 that is generated by the second message 520, and smart content C2 that is created as abstract information corresponding to the combination of the first message 510 and the second message 520.

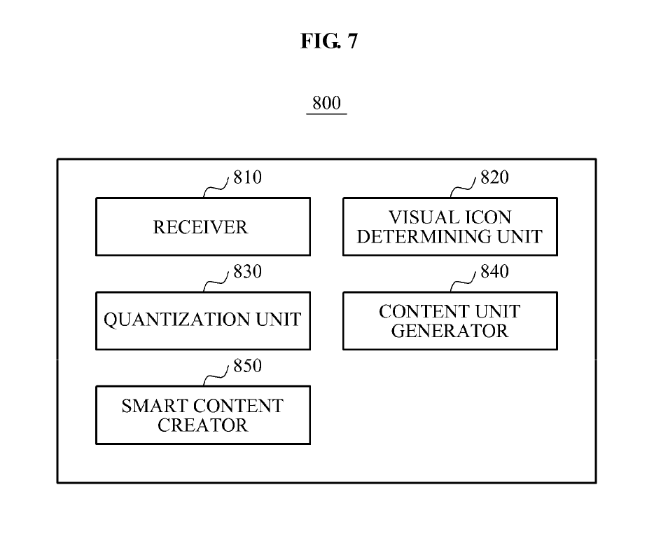

FIG. 7 is a block diagram illustrating a configuration of a system 800 according to an embodiment of the present invention.

Referring to FIG. 7, the system 800 may include a receiver 810, a visual icon determining unit 820, a quantization unit 830, a content unit generator 840, and a smart content creator 850.

The receiver 810 may receive, from a social network service (SNS) server, contents that are registered by users.

The visual icon determining unit 820 may determine a visual icon that represents each of the contents based on the respective contents.

The quantization unit 830 may quantize each of a plurality of visual icons to map each of the plurality of visual icons with at least one level among a plurality of predetermined quantization levels.

The content unit generator 840 may generate a content unit corresponding to each of the plurality of visual icons based on the mapping result.

The smart content creator 850 may create smart content that is a visual expression as abstract information corresponding to a combination of the contents, based on a combination of content units.

In particular, the smart content creator 850 may create smart content corresponding to the combination of contents by further referring to smart content that is created by another social community.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of managing content using a visual expression, the method comprising:
determining a visual icon that represents each of contents registered by users, based on the respective contents;
quantizing each of a plurality of visual icons to map each of the plurality of visual icons with at least one level among a plurality of predetermined quantization levels;
generating a content unit corresponding to each of the plurality of visual icons based on the mapping result; and
creating smart content that is a visual expression as abstract information corresponding to a combination of the contents, based on a combination of content units.

2. The method of claim 1, wherein the quantizing comprises quantizing each of the plurality of visual icons by further referring to a sentiment index or an emotional index that is predetermined with respect to community of the users.

3. The method of claim 1, wherein the creating comprises visually combining the content units and selecting the combination result as the smart content.

4. The method of claim 1, wherein the creating comprises searching for a new content unit based on information that is commonly included in the quantization results of the plurality of visual icons, and selecting the new content unit as the smart content.

5. The method of claim 1, wherein the creating comprises searching for a new content unit based on all of or a portion of information that is included in the quantization results of the plurality of visual icons, and selecting the new content unit as the smart content.

6. The method of claim 1, further comprising:
receiving, from a social network service (SNS) server, the contents that are registered by the users.

7. The method of claim 1, wherein the smart content comprises a video or an image.

8. The method of claim 1, further comprising:
updating the smart content in response to a new content being provided.

9. The method of claim 1, further comprising:
playing the created smart content.

10. A non-transitory computer-readable recording medium storing a program to implement the method of claim 1.

11. A system for managing content using a visual expression, the system comprising:
a receiver to receive, from a social network service (SNS) server, contents that are registered by users;
a visual icon determining unit to determine a visual icon that represents each of the contents based on the respective contents;
a quantization unit to quantize each of a plurality of visual icons to map each of the plurality of visual icons with at least one level among a plurality of predetermined quantization levels;
a content unit generator to generate a content unit corresponding to each of the plurality of visual icons based on the mapping result; and
a smart content creator to create smart content that is a visual expression as abstract information corresponding to a combination of the contents, based on a combination of content units.

12. The system of claim 11, wherein the smart content creator creates the smart content corresponding to the combination of contents by further referring to smart content created in another social community.
